(19) United States
(12) Patent Application Publication
(10) Pub. No.: US 2015/0143070 A1
(43) Pub. Date: May 21, 2015

(54) NONVOLATILE STORAGE AND OPERATING METHODS OF COMPUTING DEVICES INCLUDING THE NONVOLATILE STORAGE

(71) Applicant: Samsung Electronics Co., Ltd., Suwon-Si, (KR)

(72) Inventors: Jaegyu LEE, Suwon-si (KR); Jisoo KIM, Yongin-si (KR); Wonchul JU, Seoul (KR)

(21) Appl. No.: 14/495,099

(22) Filed: Sep. 24, 2014

Related U.S. Application Data
(60) Provisional application No. 61/905,953, filed on Nov. 19, 2013.

(30) Foreign Application Priority Data
Dec. 16, 2013 (KR) 10-2013-0156520

(51) Int. Cl. G06F 12/02

(52) U.S. Cl. CPC G06F 12/023
USPC 711/173

(57) ABSTRACT

An writing and reading method of a nonvolatile Storage, that includes a first partition and a second partition, and is configured to allow a read operation and a write operation with respect to the second partition only when an authentication is successful in a normal mode, may comprise: assigning a part of a storage space of the second partition to a temporary area by the nonvolatile storage according to a request of changing the normal mode to a secure temporary mode; and/or writing data to the temporary area by the nonvolatile storage. The nonvolatile storage may allow the read operation and with respect to the temporary area without the authentication.

### CROSS-REFERENCE TO RELATED APPLICATION(S)

This application claims the benefit of U.S. provisional patent application No. 61/905,953, filed on Nov. 19, 2013, in the U.S. Patent and Trademark Office (USPTO), and claims priority from Korean Patent Application No. 10-2013-0156520, filed on Dec. 16, 2013, in the Korean Intellectual Property Office (KIPO), the entire contents of both of which are incorporated herein by reference.

### BACKGROUND

1. Field

Some example embodiments of the present inventive concepts may relate to a nonvolatile storage. Some example embodiments of the present inventive concepts may relate to operating methods of computing devices including the nonvolatile storage.

2. Description of Related Art

A semiconductor memory device may be a memory device which is embodied using semiconductor(s) such as silicon (Si), germanium (Ge), gallium arsenide (GaAs), indium phosphide (InP), etc. Semiconductor memory devices may be classified into volatile memory devices and nonvolatile memory devices.

A volatile memory device may lose its stored data when its power supply is interrupted. Examples of volatile memory devices may include certain types of random-access memory (RAM), such as a static RAM (SRAM), a dynamic RAM (DRAM), a synchronous DRAM (SDRAM), etc. A nonvolatile memory device may retain its stored data even when its power supply is interrupted. Examples of nonvolatile memory devices may include a read only memory (ROM), a programmable ROM (PROM), an erasable programmable ROM (EPROM), an electrically erasable and programmable ROM (EEPROM), a flash memory, a phase-change RAM (PRAM), a magnetic or magnetoresistive RAM (MRAM), a resistive RAM (RRAM), a ferroelectric RAM (FRAM), etc.

A mobile computing device such as a smart phone, a smart pad, etc., may use a random-access memory as a main memory and may use a nonvolatile memory as a storage. The main memory may be a memory (for example, an operation memory) being used when the mobile computing device performs codes or processes data. The storage may be a memory being used when the mobile computing device preserves data for long time.

The mobile computing device may have a limited power supply such as a battery and may have a weight limit to provide mobility. The mobile computing device also may have a price limit for commercialization like other electronic devices. Thus, the mobile computing device may be manufactured to have a limited resource (for example, a limited memory capacity, a limited computing power, etc.). Technologies for optimizing operation performance of the mobile computing device having a limited resource of a mobile computing device may continue to be required.

### SUMMARY

Example embodiments of the inventive concepts may provide writing and reading method of a nonvolatile storage that includes a first partition and a second partition, and is configured to allow a read operation and a write operation with respect to the second partition only when an authentication is successful in a normal mode.

Example embodiments of the inventive concepts also may provide writing and reading methods of the nonvolatile storage that include an operation in which the nonvolatile storage assigns a part of a storage space of the second partition to a temporary area according to a request of changing the normal mode to a secure temporary mode; and an operation in which the nonvolatile storage writes data to the temporary area. The nonvolatile storage may allow the read operation with respect to the temporary area without the authentication.

In some example embodiments, the temporary area is assigned when a capacity of a free storage space of the first partition is smaller than a size of the data.

In some example embodiments, the reading and writing method may further comprise: receiving information of a capacity of the temporary area by the nonvolatile memory. The temporary area may be assigned according to the information of the capacity.

In some example embodiments, the temporary area is assigned when the capacity of the temporary area is smaller than a capacity of a free storage space of the second partition.

In some example embodiments, the assigning of the part of the storage space to the temporary area comprises extending the first partition so that addresses of the part of the storage space is included in the first partition.

In some example embodiments, the part of the storage space belongs to both the second partition and the first partition.

In some example embodiments, the assigning of the part of the storage space to the temporary area comprises generating a temporary partition by separating the part of the storage space from the second partition. The nonvolatile storage may allow the read operation with respect to the temporary partition without the authentication.

In some example embodiments, the temporary area is assigned when a capacity of a free storage space of the first partition is smaller than a size of the data, and a capacity of a free storage space of the second partition is greater than the size of the data.

In some example embodiments, the reading and writing method may further comprise: receiving addresses of the part of the storage space to be assigned to the temporary area by the nonvolatile storage.

In some example embodiments, the assigning of the part of the storage space to the temporary area comprises storing the received addresses by the nonvolatile storage. The nonvolatile storage allows the read operation or the write operation without the authentication based on the stored addresses.

In some example embodiments, the part of the storage space may be selected from a free storage space of the second partition.

In some example embodiments, the reading and writing method may further comprise after the read operation of the temporary area, receiving an end request by the nonvolatile storage; and/or releasing the part of the storage space from the temporary area by the nonvolatile storage according to the end request.

In some example embodiments, the reading and writing method may further comprise: receiving a delete request of the data written in the temporary area in conjunction with the end request by the nonvolatile storage; and/or deleting the data according to the delete request by the nonvolatile storage.

In some example embodiments, the reading and writing method may further comprise: deleting the data written in the temporary area by the nonvolatile storage according to the end request.

In some example embodiments, a nonvolatile storage may comprise: a nonvolatile memory forming a storage area; and/or a memory controller configured to access the storage area. The storage area is configured to be divided into a first partition and a second partition. The second partition is configured to be set to be accessed according to an external request after an authentication is successful in a normal mode. A part of the storage area of the second partition is re-configured to be accessed without the authentication according to the external request in a secure temporary mode

In some example embodiments, an operating method of a computing device that includes a nonvolatile storage and a processor, wherein the nonvolatile storage includes one or more normal partitions and one or more secure partitions, and wherein the processor is configured to access the nonvolatile memory, may comprise: in a first mode, assigning a part of a storage space of at least one of the one or more secure partitions to a temporary area by the nonvolatile storage in response to a request from the processor; writing data into the temporary area in the secure partition by the processor; and/or reading the data from the temporary area in a second mode by the processor. The nonvolatile storage may be configured to allow read operations with respect to the one or more secure partitions only when an authentication is successful in the first mode. The nonvolatile storage may be configured to allow the read operations with respect to the temporary area without the authentication in the second mode.

In some example embodiments, at the first mode, the processor is configured to access the one or more secure partitions after the authentication is successful using a key. At the second mode, the processor is configured to be unable to obtain the key.

In some example embodiments, the written data is for updating an operating system or a firmware.

In some example embodiments, the operating method may further comprises: releasing the temporary area after reading the written data by the processor.

In some example embodiments, the operating method may further comprises: deleting the written data when the temporary area is released by the nonvolatile storage.

### BRIEF DESCRIPTION OF THE FIGURES

The above and/or other aspects and advantages will become more apparent and more readily appreciated from the following detailed description of example embodiments, taken in conjunction with the accompanying drawings, in which:

FIG. 1 is a block diagram illustrating a computing device in accordance with some example embodiments of the inventive concepts.

FIG. 2 illustrates a storage space of storage.

FIG. 3 is a flow chart illustrating an operating method of a computing device in accordance with some example embodiments of the inventive concepts.

FIG. 4 is a flow chart illustrating an operating method of a host in accordance with some example embodiments of the inventive concepts.

FIG. 5 is a flow chart illustrating an operating method of storage in accordance with some example embodiments of the inventive concepts.

FIG. 6 is a flow chart illustrating a process that a host and storage assign a temporary area.

FIG. 7 illustrates a first example that storage assigns a temporary area.

FIG. 8 illustrates a second example that storage assigns a temporary area.

FIG. 9 is a flow chart illustrating an operating method of a host in accordance with some example embodiments of the inventive concepts.

FIG. 10 is a flow chart illustrating an operating method of storage in accordance with some example embodiments of the inventive concepts.

FIG. 11 is a flow chart illustrating a second example of a process that a host and storage assign a temporary area.

FIG. 12 illustrates a third example that storage assigns a temporary area.

FIG. 13 is a flow chart illustrating an operation of a host releasing a temporary area.

FIG. 14 is a flow chart illustrating an operation of storage releasing a temporary area.

FIG. 15 is a flow chart illustrating an example that a computing device uses a temporary area.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Example embodiments may be described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will typically have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature, their shapes are not intended to illustrate the actual shape of a region of a device, and their shapes are not intended to limit the scope of the example embodiments.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

Reference will now be made to example embodiments, which are illustrated in the accompanying drawings, wherein like reference numerals may refer to like components throughout.

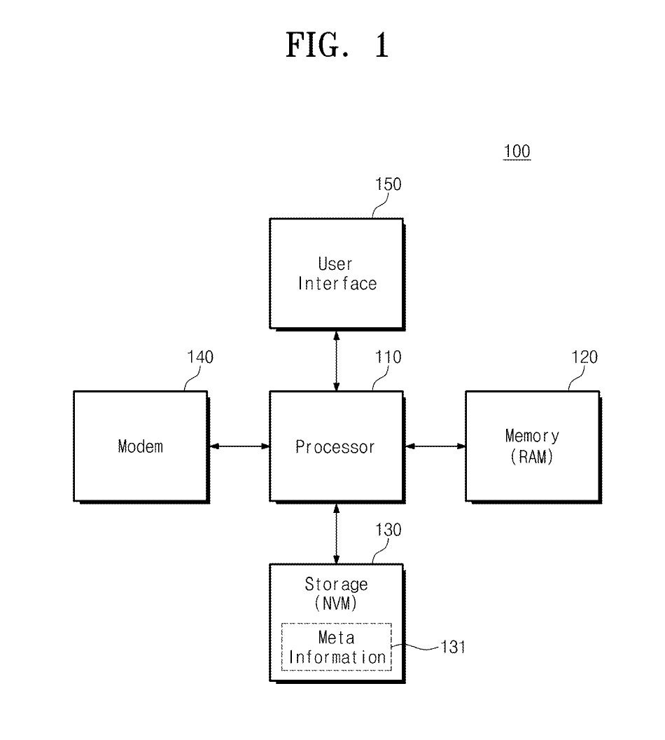

FIG. 1 is a block diagram illustrating a computing device in accordance with some example embodiments of the inventive concepts. Referring to FIG. 1, a computing device 100 includes a processor 110, a memory 120, a storage 130, a modem 140, and a user interface 150.

The processor 110 can control the overall operation of the computing device 100 and can perform a logical operation. The processor 110 may be constituted by a system-on-chip (SOC). The processor 110 may be a general-purpose processor being used in a general-purpose computer, a special-purpose processor being used in a special-purpose computer, or an application processor being used in a mobile computing device.

The memory 120 can communicate with the processor 110. The memory 120 may be a main memory of the processor 110 or the computing device 100. The processor 110 can temporarily store codes or data in the memory 120. The processor 110 can execute the codes or process the data using the memory 120. The processor 110 can execute various kinds of software such as an operating system and an application using the memory 120. The processor 110 can control overall operations of the computing device 100 using the memory 120. The memory 120 may include a volatile memory, such as a SRAM, a DRAM, a SDRAM, etc. The memory 120 may include a nonvolatile memory, such as a flash memory, a PRAM, a MRAM, a RRAM, a FRAM, etc. The memory 120 can be constituted by a random-access memory.

The storage 130 can communicate with the processor 110. The storage 130 can store data which has to be preserved for long time. That is, the processor 110 can store data which has to be preserved for long time in the storage 130. The storage 130 can store a boot image for driving the computing device 100. The storage 130 can store source codes of various kinds of software such as an operating system and an application. The storage 130 may include a nonvolatile memory (NVM) such as a flash memory, a PRAM, a MRAM, a RRAM, a FRAM, etc. The storage 130 may further includes a controller configured to control the nonvolatile memory.

The storage 130 can store meta information 131. The meta information 131 may include data needed to manage or access the storage 130. The processor 110 can read the meta information 131 and can access and manage the storage on the basis of the meta information 131.

The processor 110 can drive various kinds of software such as an operating system and an application by loading source codes stored in the storage 130 into the memory 120 and executing the codes loaded into the memory 120. The processor 110 can load data stored in the storage 130 in the memory 120 and can process the data loaded in the memory 120. The processor 110 can store data which has to be preserved for long time in the storage 130.

The modem 140 can communicate with an external device under the control of the processor 110. The modem 140 can perform a wired or wireless communication with an external device. The modem 140 can perform a communication on the basis of at least one of various wireless communication methods such as LTE (long-term evolution), worldwide interoperability for microwave access (WiMAX), GSM (global system for mobile communications), CDMA (code-division multiple access), Bluetooth, NFC (near field communication), WiFi, RFID (radio-frequency identification), etc., or at least one of various wired communication methods such as USB (universal serial bus), SATA (serial advanced technology attachment), SCSI (small computer system interface), FireWire, PCI (peripheral component interconnect), etc.

The user interface 150 can communicate with a user under the control of the processor 110. The user interface 150 may include user input interfaces such as a keyboard, a button, a touch panel, a touch screen, a touch pad, a touch ball, a camera, a microphone, a gyroscope sensor, a vibration sensor, etc. The user interface 150 may include user output interfaces such as LCD (liquid-crystal display), OLED (organic light-emitting diode) display, AMOLED (active-matrix OLED) display, a LED (light-emitting diode) speaker, a motor, etc.

The computing device 100 can form a mobile computing device such as a smart phone, a smart pad, a smart camera, etc. The computing device 100 can form various devices such as a personal computer, a notebook computer, a smart television, etc.

The term ‘host’ is used in contrast to the storage 130. The host is a master of the storage 130 and may be a device accessing or managing the storage 130. In the computing device 100 illustrated in FIG. 1, the host may include the processor 110. A range of the host is not limited to the processor 110. A device having the authority to access or manage the storage 130 may be included in the range of the host. In the case that the modem 140 has the authority to access or manage the storage 130, the modem 140 may also be included in the host. An external device (for example, an external server or an external computing device) having the authority to access or manage the storage 130 through the modem 140 may also be included in the host. Various kinds of software that can access or manage the storage 130 such as an operating system and an application may be included in the host.

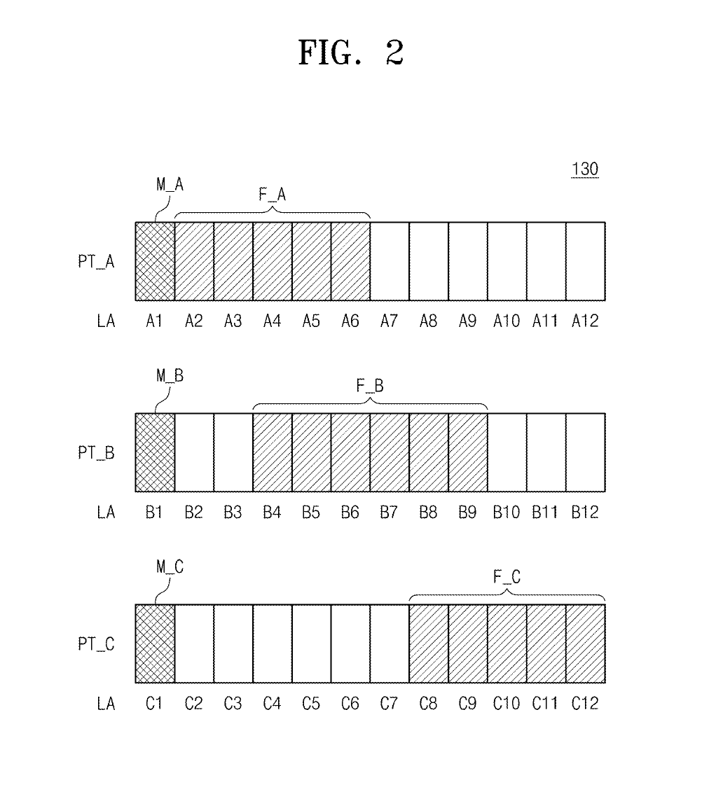

FIG. 2 illustrates a storage space of storage 130. Referring to FIGS. 1 and 2, the storage 130 is divided into a first partition PT_A, a second partition PT_B, and a third partition PT_C.

The first partition PT_A may include storage spaces corresponding to first through twelfth addresses A1˜A12 respectively. First meta information M_A may be stored in a storage space of the first address A1 of the first partition PT_A. The first meta information M_A may include information about a capacity, an address, and a structure of the first partition PT_A. A first file F_A may be stored in storage spaces of the second through sixth addresses A2˜A6.

The first partition PT_A may be a normal partition. The normal partition indicates a partition having no limitation when performing read and write operations. When a read or write request with respect to the first partition PT_A is received from the host, the storage 130 can allow the read or write request without authentication.

The second partition PT_B may include storage spaces corresponding to first through twelfth addresses B1˜B12 respectively. Second meta information M_B may be stored in the storage space of the first address B1 of the second partition PT_B. The second meta information M_B may include information about a capacity, an address, and a structure of the second partition PT_B. A second file F_B may be stored in storage spaces of the fourth through ninth addresses B4˜B9.

The second partition PT_B may be a secure partition. The secure partition indicates a partition in which read and write operations are allowed only when authentication is successful. When accessing the secure partition, the host may transmit a key (or a password) to the storage 130. When the key (or password) transmitted from the host has a correct value, the storage 130 can allow an access (for example, read operation or write operation) to the secure partition.

The third partition PT_C may include storage spaces corresponding to first through twelfth addresses C1˜C12 respectively. Third meta information M_C may be stored in the storage space of the first address C1 of the third partition PT_C. The third meta information M_C may include information about a capacity, an address, and a structure of the third partition PT_C. A third file F_C may be stored in storage spaces of the eighth through twelfth addresses C8˜C12. The third partition PT_C may be a secure partition.

The storage 130 can store information about the secure partitions PT_B and PT_C as the meta information 131. The storage 130 can store information indicating that the addresses B1˜B12 correspond to a secure partition and information of a key (or a password) as the meta information 131. The storage 130 can store information indicating that the addresses C1˜C12 correspond to a secure partition and information of a key (or a password) as the meta information 131.

When an access request for the addresses B1˜B12 is received from the host, the storage 130 can perform an authentication with reference to the meta information 131. For example, the storage 130 can determine whether a key (or a password) being received from the host coincides with a key (or a password) registered as the meta information 131. If it is determined that a key (or a password) being received from the host coincides with a key (or a password) registered as the meta information 131, the storage 130 can allow the access request. If not, the storage 130 can reject the access request. Similarly, when an access request for the addresses C1˜C12 is received from the host, the storage 130 performs an authentication with reference to the meta information 131 and can allow or reject the access request depending on an authentication result.

An authentication of an access request of the secure partition is performed by the storage 130. Thus, even in the case that an operating system having a root authority of the computing device 100 accesses a secure partition, if authentication is not successful, an access is rejected.

In FIG. 2, the storage 130 is divided into three partitions PT_A, PT_B, and PT_C. However, the number of partitions of the storage 130 is not limited. The storage 130 can be divided into at least one normal partition and at least one secure partition.

The storage 130 of FIG. 2 may be used in more general purpose computing devices. For example, the storage 130 may be used in smart phones so as to permit secure and/or non-secure read and/or write operations of the smart phones when sending and receiving text messages.

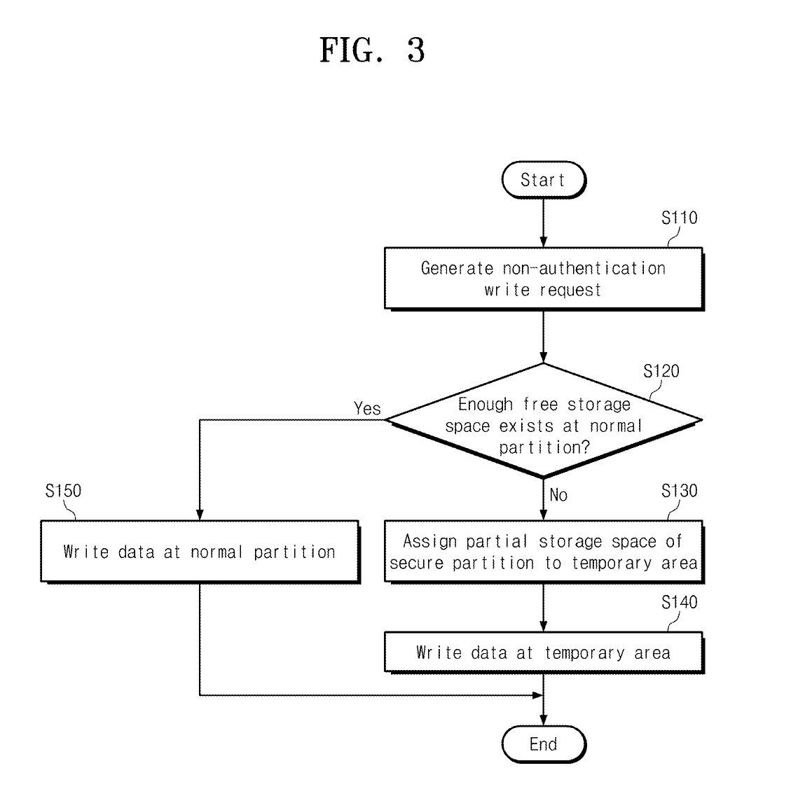

FIG. 3 is a flow chart illustrating an operating method of a computing device in accordance with some example embodiments of the inventive concepts. Referring to FIGS. 1 through 3, in an operation S110, a non-authentication write request is generated. The non-authentication write request may be a request to write data to be read without an authentication later. For example, the non-authentication write request may be a request to write data to be read later in an environment in which an authentication is impossible. The non-authentication write request may include a write request with respect to a normal partition.

In operation S120, it is determined whether sufficient storage space exists in a normal partition. For example, the host can compare a capacity of a free storage space of the normal partition of the storage 130 with a size of the write data. If the capacity of the free storage space of the normal partition is greater than the size of the write data, it may be determined that sufficient storage space exists in the normal partition. If the capacity of the free storage space of the normal partition is smaller than the size of the write data, it may be determined that sufficient storage space does not exist in the normal partition.

If sufficient storage space does not exist in the normal partition, in operation S130, a part of a storage space of the secure partition is assigned as a temporary area. The temporary area may be a normal area (or the normal partition) that does not need a key (or a password) even though it was the part of the secure partition. After that, in operation S140, the write data is written in the temporary area.

If sufficient storage space exists in the normal partition, in operation S150, the write data is written in the normal partition.

As described above, in the case that data to be read later at non-authentication state needs to be written and a capacity of a free storage space of the normal partition is insufficient, a part of a storage space of the secure partition is assigned as the temporary area. The temporary area is set as an area that does not need an authentication. The temporary area is a normal area (or the normal partition) that does not need a key (or a password). Thus, data written in the storage 130 according to a non-authentication write request can be read later without authentication.

The method of FIG. 3 may be used in operating more general purpose computing devices. For example, the method may be used in operating notebook computers so as to permit secure and/or non-secure read and/or write operations of the notebook computers when downloading software.

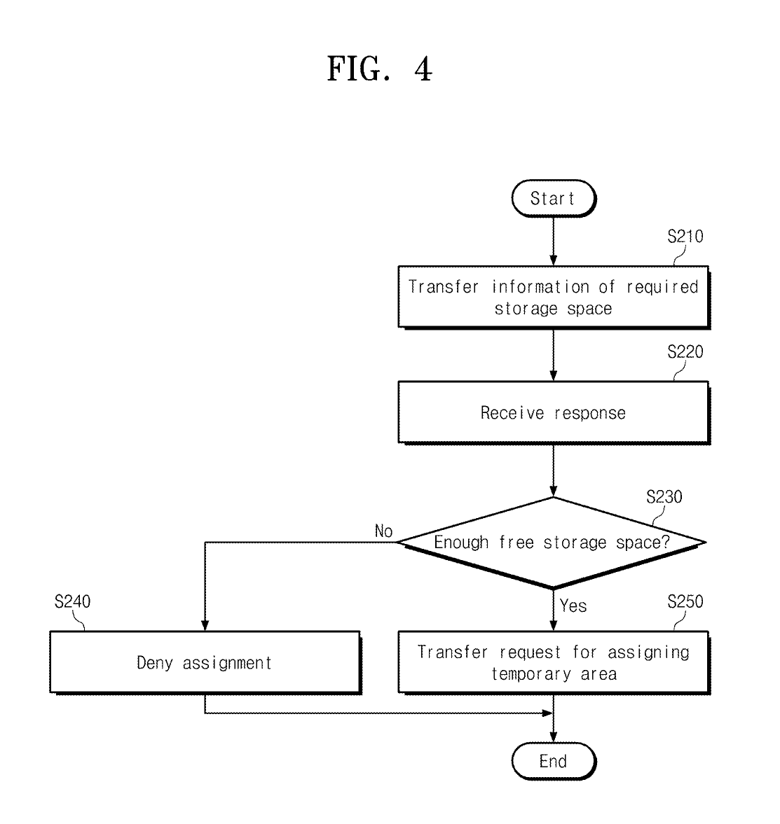

FIG. 4 is a flow chart illustrating an operating method of a host in accordance with some example embodiments of the inventive concepts. As an illustration, an operating method of a host when a part of storage space of the secure partition is assigned as a temporary area (the operation S130 of FIG. 3) is illustrated in FIG. 4.

Referring to FIGS. 1, 2, and 4, in operation S210, the host transmits information of a necessary storage space to the storage 130. The information of the necessary storage space may include information about a capacity of a part of a storage space to be assigned as a temporary area. The capacity of the part of the storage space to be assigned as the temporary area may be determined by a size of data that has to be written in the normal partition. The capacity of the part of the storage space to be assigned as the temporary area may be determined to be greater than the size of the data that has to be written in the normal partition.

In operation S220, the host receives a response from the storage 130. The response may include information about whether sufficient free storage space exists in the storage 130. For example, the response may include information about whether a capacity of a free storage space of the secure partition is greater than the capacity of the necessary storage space.

In operation S230, on the basis of the response, it is determined whether sufficient free storage space exists in the storage 130. If sufficient free storage space does not exist in the storage 130, in operation S240, an assignment of the temporary area is rejected. The host may stop a write operation. If sufficient free storage space exists in the storage 130, in operation S250, the host can ask the storage 130 for an assignment of the temporary area.

The method of FIG. 4 may be used in operating more general purpose computing devices. For example, the method may be used in operating smart cameras so as to permit secure and/or non-secure read and/or write operations of the smart cameras when storing photographic files.

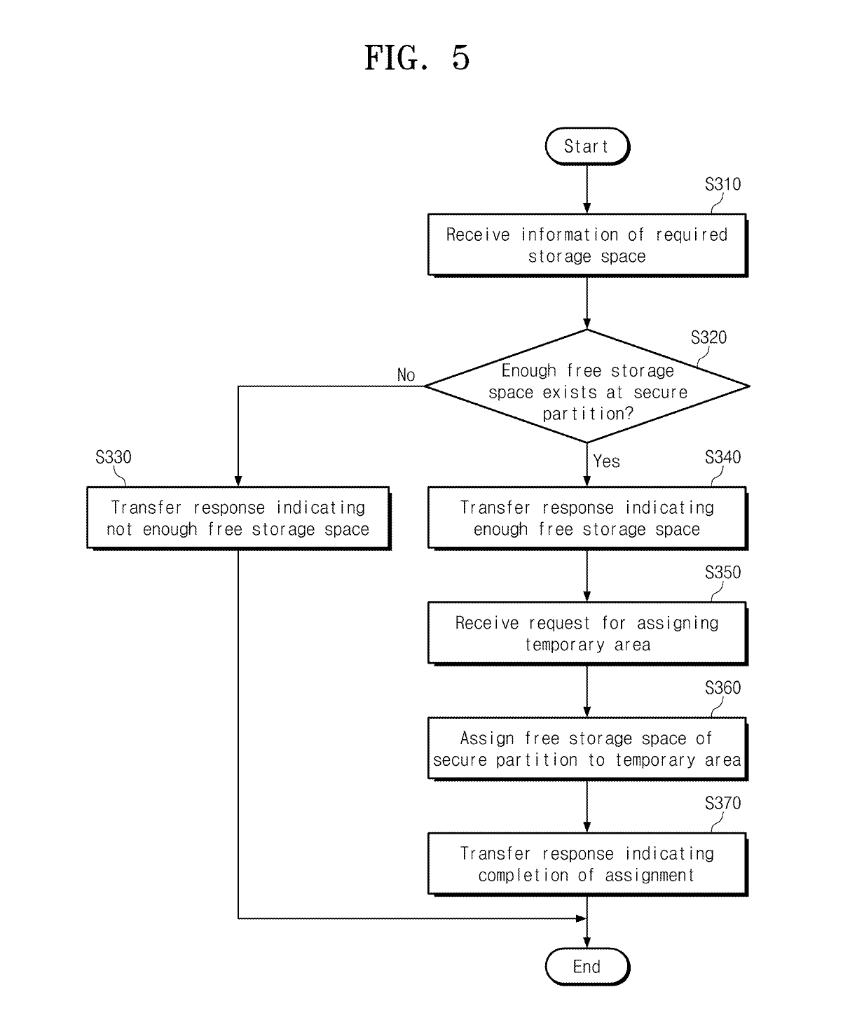

FIG. 5 is a flow chart illustrating an operating method of a storage in accordance with some example embodiments of the inventive concepts. As an illustration, an operating method of a storage 130 when a part of a storage space of the secure partition is assigned as a temporary area (the operation S130 of FIG. 3) is illustrated in FIG. 5.

Referring to FIGS. 1, 2, and 5, in operation S310, the storage 130 can receive information of the necessary storage space from the host.

In operation S320, it is determined whether sufficient free storage space exists in the secure partition. For example, it may be determined whether a capacity of a free storage space of the secure partition is greater than a capacity of the necessary storage space.

If sufficient free storage space does not exist in the secure partition, in operation S330, the storage 130 transmits a response indicating that sufficient free storage space does not exist to the host.

If sufficient free storage space exists in the secure partition, in operation S340, the storage 130 transmits a response indicating that sufficient free storage space exists to the host. In operation S350, the storage 130 can receive a request for an assignment of the temporary area from the host. In operation S360, the storage 130 assigns the free storage space of the secure partition as the temporary area. In operation S370, the storage 130 can transmit a response indicating that an assignment is completed to the host.

The method of FIG. 5 may be used in operating more general purpose computing devices. For example, the method may be used in operating smart appliances so as to permit secure and/or non-secure read and/or write operations of the smart appliances when managing the functions of the smart appliances.

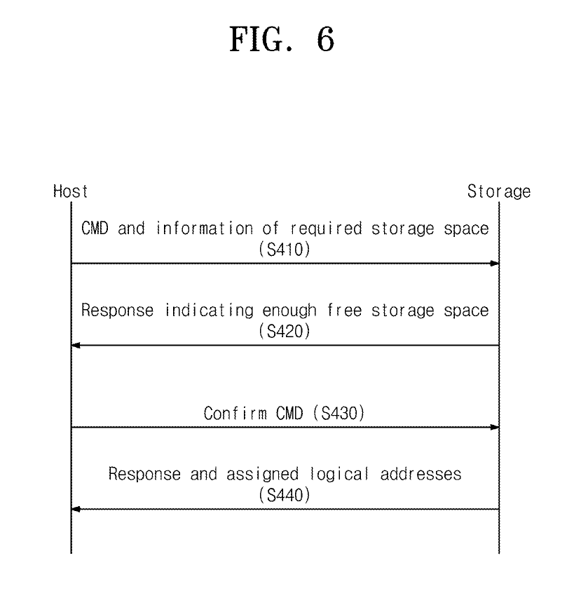

FIG. 6 is a flow chart illustrating a process that a host and a storage assign a temporary area. Referring to FIGS. 1 and 6, in operation S410, the host transmits a command (CMD) and information of a necessary storage space to the storage 130. The command may be a command requesting that a part of a storage space of the secure partition is assigned to the temporary area. The information of the necessary storage space may include information of the capacity of a free storage space needed as the temporary area.

In operation S420, the storage 130 can transmit a response indicating that sufficient free storage space exists to the host.

In operation S430, the host can transmit a confirm command to the storage 130. For example, the confirm command may be a command confirming an assignment of the temporary area.

In operation S440, the storage 130 can assign the temporary area in response to the confirm command and can transmit a response indicating that an assignment of the temporary area is completed to the host, together with addresses assigned to the temporary area.

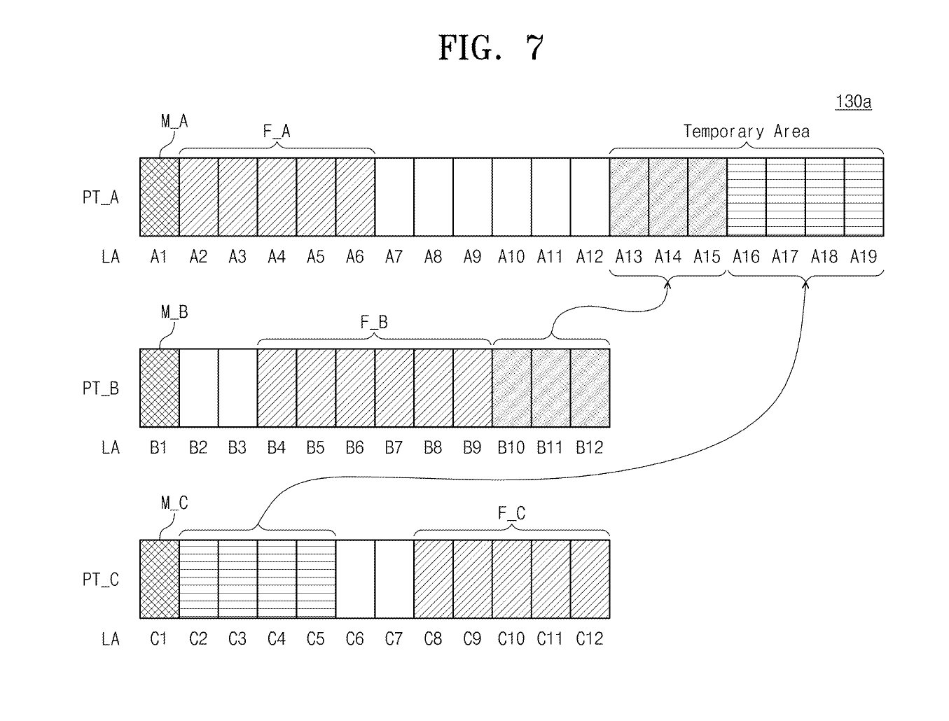

FIG. 7 illustrates a first example that a storage 130 assigns a temporary area. Referring to FIGS. 1 and 7, it is assumed that data to be written in the first partition PT_A which is a normal partition needs a capacity corresponding to seven addresses. A capacity of a free storage space of the first partition PT_A corresponds to six addresses. Thus, the capacity of the free storage space of the first partition PT_A is insufficient and it is necessary to assign the temporary area.

A storage 130a can select a free storage space corresponding to three addresses B10˜B12 from the second partition PT_B which is the secure partition and can select a free storage space corresponding to four addresses C2˜C5 from the third partition PT_C. That is, the storage 130a can select a free storage space corresponding to a capacity needed for the temporary area from the second and third partitions PT_B and PT_C, which are secure partitions.

The storage 130a can extend the first partition PT_A as the selected free storage space is added to the first partition PT_A. That is, a storage spaces corresponding to seven addresses A13˜A19 may be added to the first partition PT_A. Accordingly, the first partition PT_A can be extended to have the storage spaces corresponding to the seven addresses A13˜A19.

The selected free storage spaces can be maintained in the second and third partitions PT_B and PT_C. That is, even though storage spaces corresponding to the addresses B10˜B12 are added to the first partition PT_A, the second partition PT_B still may maintain the storage spaces corresponding to addresses B10˜B12. Even though storage spaces corresponding to the addresses C2˜C5 are added to the first partition PT_A, the third partition PT_C still may maintain the storage spaces corresponding to the addresses C2˜C5.

It can be recognized that a part of the storage space of the second partition PT_B being assigned to the temporary area temporarily belongs to both the first partition PT_A and the second partition PT_B. Similarly, it can be recognized that a part of the storage space of the third partition PT_C being assigned to the temporary area temporarily belongs to both the first partition PT_A and the third partition PT_C.

The temporary area can be constituted by addresses out of range of addresses being provided from the storage 130a. If the temporary area is assigned, it can be recognized that a whole storage space of the storage 130a is temporarily increased by the temporary area.

If the temporary area is assigned, the storage 130a can transmit addresses of the temporary area to a host. For example, the storage 130a can transmit the addresses A13˜A19 of the storage spaces assigned as the temporary area to the host. The addresses A13˜A19 can be transmitted from the storage 130a to the host through the operation S440 of FIG. 6.

If the temporary area is assigned, information about the temporary area may be added to meta information 131. The information being added may include information about the addresses A13˜A19 added to the first partition PT_A as the temporary area. The information being added may further include information about the type of the temporary area. The type of the temporary area may be an out of range type. The information being added may include a table 1.

TABLE 1

| Address(es) added to temporary area | Type of temporary area |
|---|---|
| A13~A19 | OOR (out of range) |

An access to a storage space except for the temporary area may be prohibited until the temporary area is released. For example, the storage 130a ignores or rejects an access to a storage space except for the temporary area. The host can be designed not to request an access to a storage space except for the temporary area.

In some example embodiments described above, it was described that the storage spaces of the addresses B10˜B12 of the second partition PT_B and the storage spaces of the addresses C2˜C5 of the third partition PT_C are selected as the temporary area. However, a reference for selecting free storage spaces of the secure partition(s) as the temporary area may be variously modified or changed.

For example, if sufficient free storage space exists in one secure partition, the temporary area can be assigned from one secure partition. A free storage space having high (or low) addresses among free storage spaces of the secure partition can be preferably selected as the temporary area. Free storage spaces having the most consecutive addresses among free storage spaces of the secure partition can be preferably selected as the temporary area.

The storage 130a of FIG. 7 may be used in more general purpose computing devices. For example, the storage 130a may be used in smart televisions so as to permit secure and/or non-secure read and/or write operations of the smart televisions during display of programming.

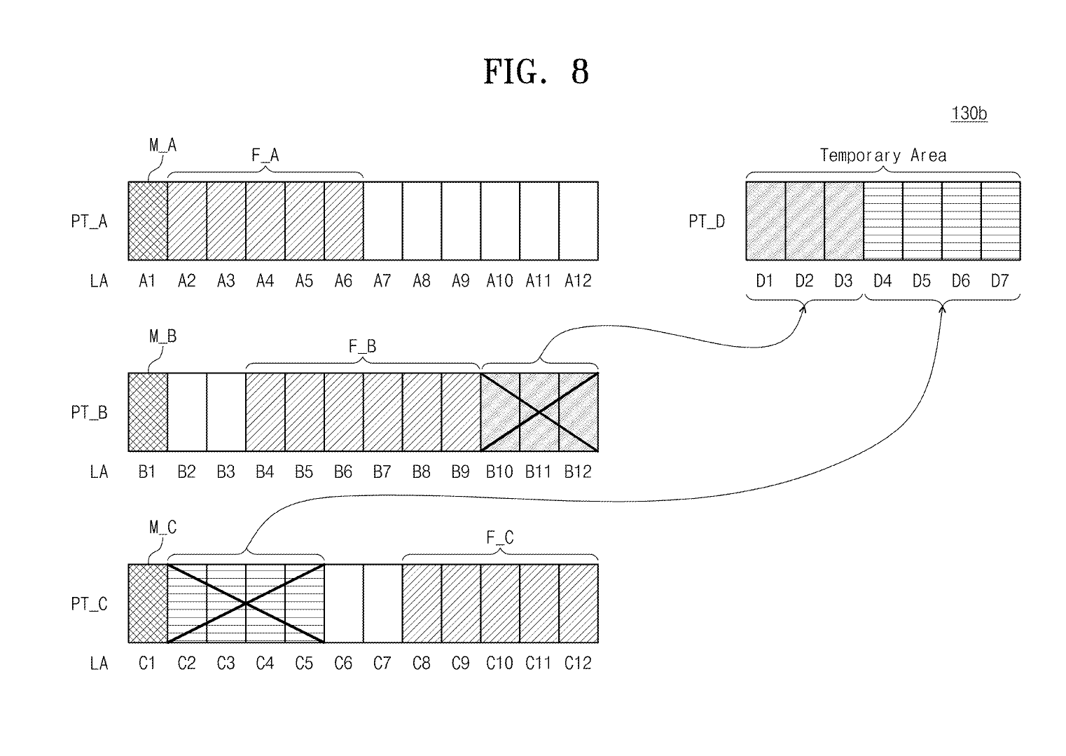

FIG. 8 illustrates a second example that a storage assigns a temporary area. Referring to FIGS. 1 and 8, as described with reference to FIG. 7, storage spaces of the addresses B10˜B12 of the second partition PT_B can be assigned to the temporary area and storage spaces of the addresses C2˜C5 of the third partition PT_C can be assigned to the temporary area.

A storage 130b can separate storage spaces selected as the temporary area, that is, storage spaces of the addresses B10˜B12 from the second partition PT_B. The storage 130b can separate storage spaces selected as the temporary area, that is, storage spaces of the addresses C2˜C5 from the third partition PT_C.

The storage 130b can assign the selected storage spaces as a fourth partition PT_D which is a new normal partition. That is, in addition to the existing normal first partition PT_A, the fourth partition PT_D which is a new normal partition may be provided. Addresses D1˜D7 may be assigned to the fourth partition PT_D. The addresses D1˜D3 can be assigned to the storage spaces selected from the second partition PT_B respectively and the addresses D4˜D7 can be assigned to the storage spaces selected from the third partition PT_C respectively.

The addresses D1˜D3 assigned to the fourth partition PT_D actually have the same value as the addresses B10˜B12 of the second partition PT_B. The addresses D4˜D7 assigned to the fourth partition PT_D actually have the same value as the addresses C2˜C5 of the third partition PT_C.

When the temporary area is assigned, it can be recognized that a whole storage space of the storage 130b is maintained and the number of partitions increases.

If the temporary area is assigned, the storage 130b can transmit addresses of the temporary area to the host. For example, the storage 130b can transmit the addresses D1˜D7 of the storage spaces of the fourth partition PT_D assigned to the temporary area to the host. The addresses D1˜D7 can be transmitted from the storage 130b to the host through the operation S440 of FIG. 6.

If the temporary area is assigned, information about the temporary area may be added to meta information 131. The information being added may include information about the addresses D1-D7 added to the fourth partition PT_D as the temporary area and information about the addresses B10˜B12 and C2˜C5 of the second and third partitions PT_B and PT_C, that is, the secure partitions from which the addresses D1˜D7 originate. The information being added may further include information about the type of the temporary area. The type of the temporary area may be a virtual logical unit type indicating that a new logical unit, that is, a fourth partition PT_D is made. The information being added may include a table 2.

TABLE 2

| Address(es) added | | |
|---|---|---|
| to temporary area | Original address | Type of temporary area |
| D1~D3 | B10~B12 | Virtual logical unit |
| D4~D7 | C2~C5 | |

As described with reference to FIG. 7, a reference for selecting free storage spaces of the secure partition as the temporary area may be variously modified or changed.

The storage 130b of FIG. 8 may be used in more general purpose computing devices. For example, the storage 130b may be used in personal computers so as to permit secure and/or non-secure read and/or write operations of the personal computers when communicating on the Internet via email.

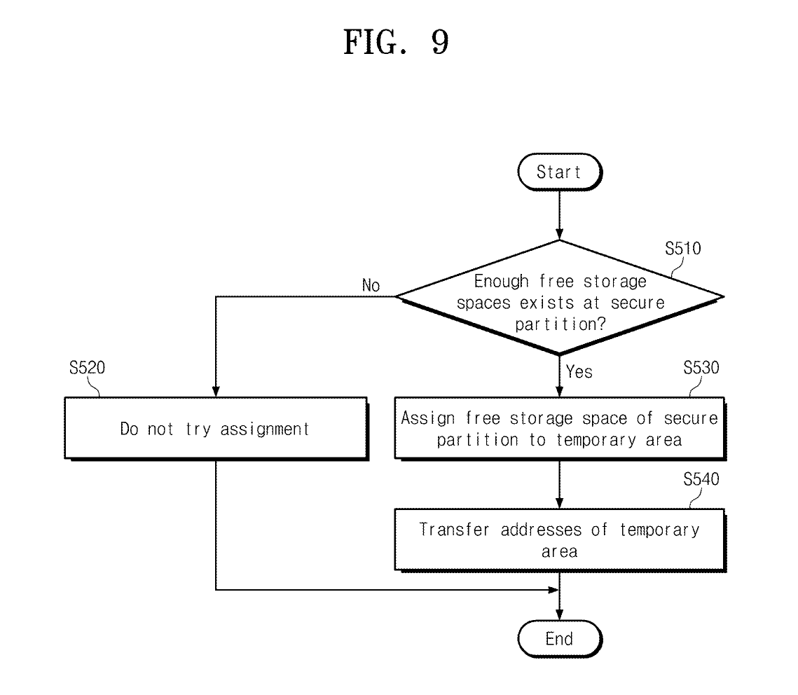

FIG. 9 is a flow chart illustrating an operating method of a host in accordance with some example embodiments of the inventive concepts. As an illustration, some example embodiments of the host of when assigning a part of a storage space of the secure partition to the temporary area (the operation S130 of FIG. 3) may be illustrated in FIG. 9.

Referring to FIGS. 1 and 9, in operation S510, the host judges whether sufficient free storage space exists in the secure partition of the storage 130. For example, the host can judge whether a capacity of a free storage space of the storage 130 is greater than a size of data which has to be written in the normal partition of the storage 130.

If sufficient free storage space does not exist in the secure partition of the storage 130, in operation S520, the host does not try an assignment of the temporary area.

If sufficient free storage space exists in the secure partition of the storage 130, in operation S530, the host assigns the free storage space of the storage 130 to the temporary area. For example, the host can select a part of addresses corresponding to the free storage space of the storage 130 as addresses of the temporary area. After that, in operation S540, the host can transmit the addresses of the temporary area to the storage 130.

The method of FIG. 9 may be used in operating more general purpose computing devices. For example, the method may be used in operating security systems so as to permit secure and/or non-secure read and/or write operations of the security systems when adjusting alarm settings.

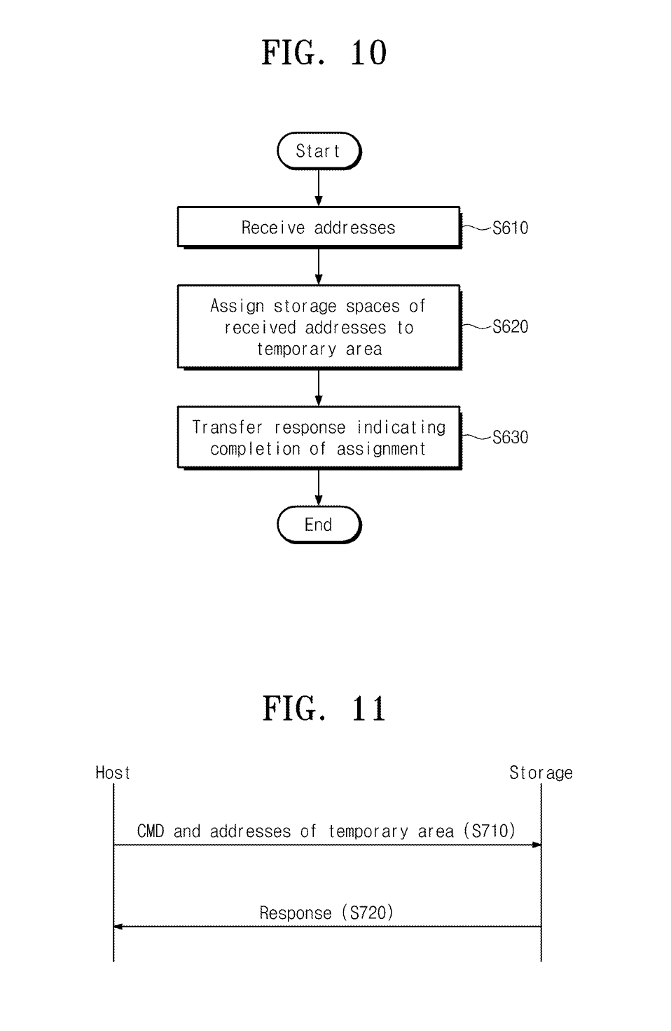

FIG. 10 is a flow chart illustrating an operating method of storage 130 in accordance with some example embodiments of the inventive concepts. As an illustration, some example embodiments of the storage 130 of when assigning a part of a storage space of the secure partition to the temporary area (the operation S130 of FIG. 3) may be illustrated in FIG. 10.

Referring to FIGS. 1 and 10, in operation S610, the storage 130 receives addresses from the host. For example, the storage 130 can receive addresses of the secure partition selected to the temporary area by the host.

In operation S620, the storage 130 assigns storage spaces of the received addresses to the temporary area.

In operation S630, the storage 130 transmits a response indicating that an assignment is completed to the host.

The method of FIG. 10 may be used in operating more general purpose computing devices. For example, the method may be used in operating climate-control systems so as to permit secure and/or non-secure read and/or write operations of the climate-control systems when adjusting temperature settings.

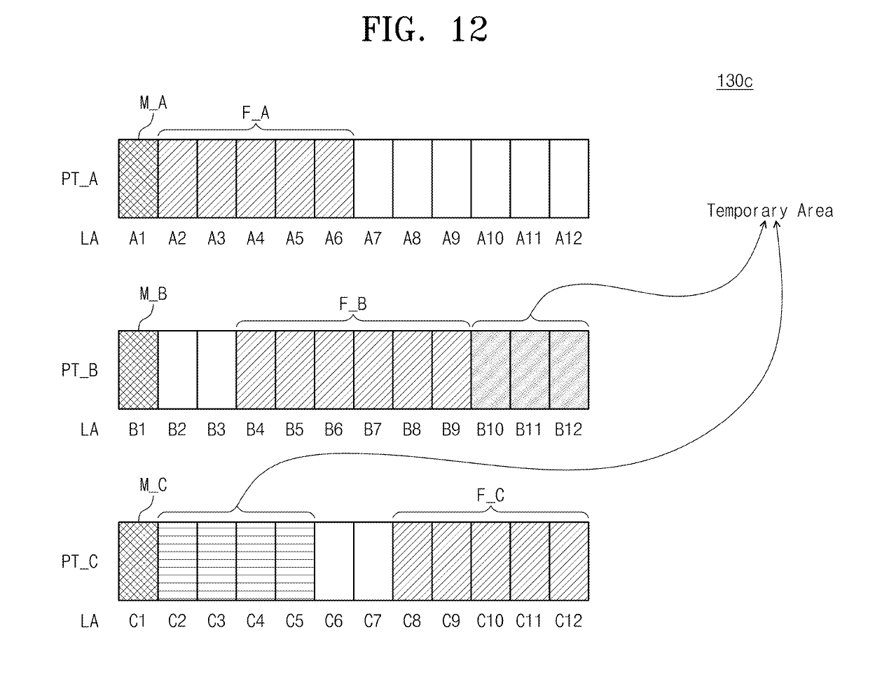

FIG. 11 is a flow chart illustrating a second example of a process that a host and a storage assign a temporary area. Referring to FIGS. 1 and 11, in operation S710, the host transmits a command and addresses of the temporary area to the storage 130. The command may be a command requesting that a part of the storage space of the secure partition is assigned to the temporary area. The addresses of the temporary may include addresses of free storage spaces selected as the temporary area by the host among free storage spaces of the secure partition of the storage 130.

In operation S720, the storage 130 can assign the temporary area according to the received addresses and can transmit a response indicating that an assignment of the temporary area is completed to the host.

FIG. 12 illustrates a third example that a storage assigns a temporary area. Referring to FIGS. 1 and 12, as described with reference to FIG. 7, storage spaces of the addresses B10˜B12 of the second partition PT_B can be assigned to the temporary area and storage spaces of the addresses C2˜C5 of the third partition PT_C can be assigned to the temporary area.

The storage 130 can select storage spaces selected as the temporary area, that is, storage spaces of the addresses B10˜B12 and C2˜C5 as the temporary area. When an access request (read or write request) for the temporary area is received from the host, the storage 130 can allow an access to the temporary area without any authentication.

When the temporary area is assigned, a whole storage space of the storage 130 is maintained and the number of the partitions may not be changed.

If the temporary area is assigned, information about the temporary area may be added to meta information 131. The information being added may include information about the addresses B10˜B12 and C2˜C5 of the second and third partitions PT_B and PT_C selected as the temporary area. The information being added may further include information about the type of the temporary area. The type of the temporary area may be a virtual partition type indicating that the temporary area is selected as a virtual partition which is the normal partition. The information being added may include a table 3.

TABLE 3

| Address(es) added to temporary area | Type of temporary area |
|---|---|
| B10~B12 | Virtual partition |
| C2~C5 | |

As described with reference to FIG. 7, a reference that free storage spaces of the secure partition are selected as the temporary area may be variously modified or changed.

The storage 130c of FIG. 12 may be used in more general purpose computing devices. For example, the storage 130c may be used in smart pads so as to permit secure and/or non-secure read and/or write operations of the smart pads when sending and receiving .pdf files.

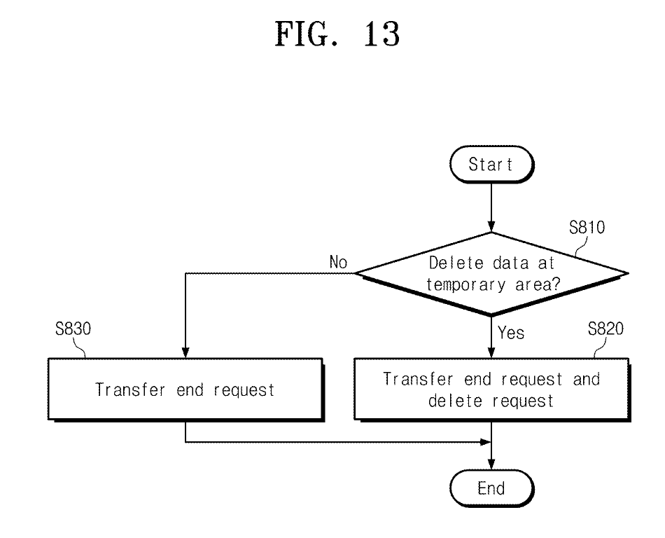

FIG. 13 is a flow chart illustrating an operation of a host releasing a temporary area. Referring to FIGS. 1 and 13, in operation S810, the host determines whether to delete or release data stored in the temporary area.

In the case that data stored in the temporary area is determined to be deleted or released, in operation S820, the host transmits an end request and a delete request (or a release request) to the storage 130.

The storage 130 can delete data according to the delete request (or release data according to the release request) and can release the temporary area according to the end request.

In the case that data stored in the temporary area is determined not to be deleted (or released), in operation S830, the host can transmit only an end request without the delete request (or the release request) to the storage 130. The storage 130 can release the temporary area without deleting (or releasing) the data stored in the temporary area.

As another illustration, the host may be configured to transmit the delete request and the end request to the storage 130 without a determining process of the operation S810. As still another illustration, the host may be configured to transmit only the end request to the storage 130 without a determining process of the operation S810.

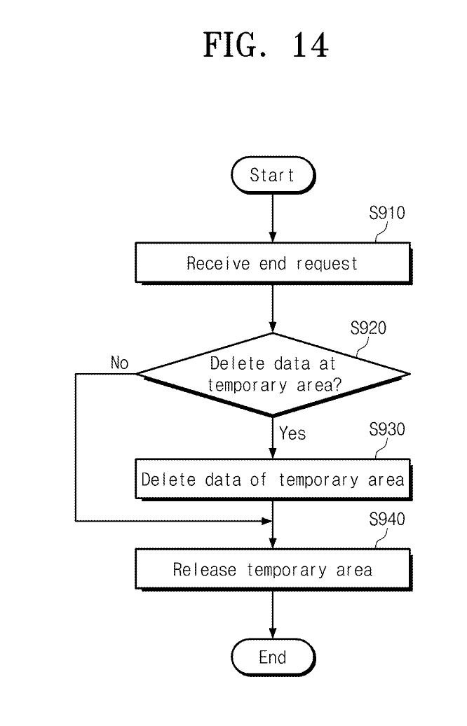

FIG. 14 is a flow chart illustrating an operating method of a storage releasing a temporary area. Referring to FIGS. 1 and 14, in operation S910, the storage 130 receives an end request from the host.

In operation S920, the storage 130 can determine whether to delete (or release) data stored in the temporary area.

If it is determined that the data stored in the temporary area is deleted (or released), in operation S930, the storage 130 can delete (or release) the data of the temporary area. After that, in operation S940, the storage 130 can release the temporary area.

If it is determined that the data stored in the temporary area is not deleted (or released), in operation S940, the storage 130 can release the temporary area without deleting (or releasing) the data of the temporary area.

As another illustration, without a determining process of the operation S920, the storage 130 can be configured to delete (or release) data of the temporary area only when the delete request is received from the host.

As an illustration, a delete of data means that the data are physically deleted. A release of data means that the data are deleted logically and the data are actually maintained physically. The logical delete may be achieved by removing mapping information between logical addresses (LA) from a host and physical addresses of a storage.

The storage 130 can release the temporary area with reference to meta information 131. The meta information 131 may include information of the table 1. The storage 130 can release the temporary area by removing the storage spaces of the addresses A13˜A19 from the first partition PT_A. Storage spaces corresponding to the addresses B10˜B12 of the second partition PT_B are removed from the first partition PT_A to be included in only the second partition PT_B. Storage spaces corresponding to the addresses C2˜C5 of the third partition PT_C are removed from the first partition PT_A to be included in only the third partition PT_C.

The meta information 131 may include information of the table 2. The storage 130 can assign storage spaces of the addresses D1˜D3 of the fourth partition PT_D to the addresses B10˜B12 of the second partition PT_B, can assign storage spaces of the addresses D4˜D7 of the fourth partition PT_D to the addresses C2˜C5 of the third partition PT_C, and can remove the fourth partition PT_D.

As still another illustration, the meta information 131 may include information of the table 3. The storage 130 can release the temporary area by removing the information of the table 3 from the meta information 131.

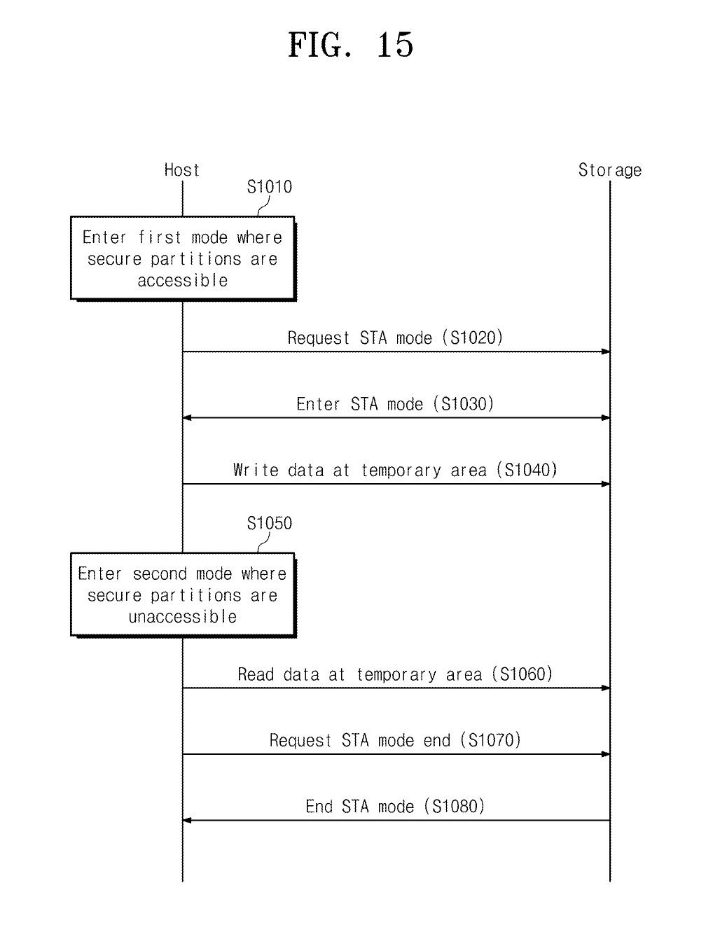

FIG. 15 is a flow chart illustrating an example that a computing device 100 uses a temporary area. Referring to FIG. 15, in operation S1010, a host can enter a first mode. The first mode may be a mode that the host can access secure partitions of a storage 130 using a key (or a password). The first mode may be usually a normal operation mode.

In operation S1020, the host can request the storage 130 for a STA (secure temporary area) mode. The STA mode may be a mode assigning a part of a storage space of one or more of the secure partitions of the storage 130 to a temporary area and accessing the assigned temporary area.

In operation S1030, the host and the storage 130 enter the STA mode. For example, according to the methods described with reference to FIGS. 1 through 14, the host and the storage 130 can assign a part of the storage space of the secure partitions of the storage 130 to the temporary area.

In operation S1040, the host can write data in the temporary area of the storage 130.

In operation S1050, the host can enter a second mode. The second mode may be a mode that the host cannot access the secure partitions of the storage 130 using a key (or a password). For example, the second mode may be a mode that the host cannot access the key (or the password).

In operation S1060, the host can read data stored in the temporary area of the storage 130. The host can read data stored in the temporary area without any authentication process.

In operation S1070, the host can transmit a STA mode end request to the storage 130.

In operation S1080, the host and the storage 130 can end the STA mode. The storage 130 can release the temporary area.

The first mode is a mode that the computing device 100 accesses the storage 130 under the control of an operating system or a firmware of the computing device 100. The second mode may be a mode for updating the operating system or the firmware of the computing device 100.

The operating system or the firmware of the computing device 100 can be performed by a specific code (for example, a code stored in a ROM of the processor 110). The specific code cannot access a key (or a password) for accessing the secure partitions of the storage 130. If data for updating the operating system or the firmware are stored in the temporary area, an update of the operating system or the firmware can be normally performed by the specific code without the key (or the password).

According to some example embodiments of the inventive concepts, in the case that a storage space of a normal partition is insufficient when data that needs access later in a non-authentication state is generated in an authentication state, a part of a storage space of a secure partition(s) of a storage is assigned to a normal partition. Thus, since an unnecessary security procedure for an authentication doesn't need to be performed in a state in which only a normal partition can access and thereby system security is improved, operating methods of nonvolatile storage providing an improved security and a computing device including the nonvolatile storage are provided.

The algorithms discussed in this application (e.g., dividing storage into at least one normal partition and at least one secure partition) may be used in more general purpose nonvolatile storage and/or methods of controlling nonvolatile storage, and/or more general purpose computing devices and/or methods of controlling computing devices. For example, the algorithms may be used in nonvolatile storage dedicated to a particular computing device or nonvolatile memory shared between multiple computing devices.

The methods described above may be written as computer programs and can be implemented in general-use digital computers that execute the programs using a computer-readable recording medium. In addition, a structure of data used in the methods may be recorded in a computer-readable recording medium in various ways. Examples of the computer-readable recording medium include storage media such as magnetic storage media (e.g., ROM (Read-Only Memory), RAM (Random-Access Memory), USB (Universal Serial Bus), floppy disks, hard disks, etc.) and optical recording media (e.g., CD-ROMs (Compact Disc Read-Only Memories) or DVDs (Digital Video Discs)).

In addition, some example embodiments may also be implemented through computer-readable code/instructions in/on a medium (e.g., a computer-readable medium) to control at least one processing element to implement some example embodiments. The medium may correspond to any medium/media permitting the storage and/or transmission of the computer-readable code.

The computer-readable code may be recorded/transferred on a medium in a variety of ways, with examples of the medium including recording media, such as magnetic storage media (e.g., ROM, floppy disks, hard disks, etc.) and optical recording media (e.g., CD-ROMs or DVDs), and transmission media such as Internet transmission media. Thus, the medium may be such a defined and measurable structure including or carrying a signal or information, such as a device carrying a bitstream according to some example embodiments. The media may also be a distributed network, so that the computer-readable code is stored/transferred and executed in a distributed fashion. Furthermore, the processing element could include a processor or a computer processor, and processing elements may be distributed and/or included in a single device.

In some example embodiments, some of the elements may be implemented as a ‘module’. According to some example embodiments, ‘module’ means software-based components or hardware components, such as a field programmable gate array (FPGA) or an application specific integrated circuit (ASIC), and the module may perform certain functions. However, the module is not limited to software or hardware. The module may be configured so as to be placed in a storage medium which may perform addressing, or to execute one or more processors.

For example, modules may include components such as software components, object-oriented software components, class components, and task components, processes, functions, attributes, procedures, subroutines, segments of program code, drivers, firmware, microcodes, circuits, data, databases, data structures, tables, arrays, and variables. Functions provided from the components and the modules may be combined into a smaller number of components and modules, or be separated into additional components and modules. Moreover, the components and the modules may execute one or more central processing units (CPUs) in a device.

Some example embodiments may be implemented through a medium including computer-readable codes/instructions to control at least one processing element of the above-described embodiment, for example, a computer-readable medium. Such a medium may correspond to a medium/media that may store and/or transmit the computer-readable codes.

The computer-readable codes may be recorded in a medium or be transmitted over the Internet. For example, the medium may include a ROM, a RAM, a CD-ROM, a magnetic tape, a floppy disc, an optical recording medium, or a carrier wave such as data transmission over the Internet. Further, the medium may be a non-transitory computer-readable medium. Since the medium may be a distributed network, the computer-readable code may be stored, transmitted, and executed in a distributed manner. Further, for example, the processing element may include a processor or a computer processor, and be distributed and/or included in one device.

Although some example embodiments have been shown and described, it would be appreciated by those skilled in the art that changes may be made in these example embodiments without departing from the principles and spirit of the example embodiments, the scope of which is defined in the claims and their equivalents. For example, while certain operations have been described as being performed by a given element, those skilled in the art will appreciate that the operations may be divided between elements in various manners.

Although some example embodiments are described above with relation to nonvolatile storage and operating methods of computing devices including the nonvolatile storage, those skilled in the art will appreciate that some example embodiments may be applied to systems used in a wide variety of fields, such as the aerospace industry, the computing industry, the financial industry, the hazardous material industry, the medical field, in military applications, the telecommunications field, and/or in more general purpose systems. Those skilled in the art will appreciate that the nonvolatile storage and operating methods of computing devices including the nonvolatile storage described in this application have a myriad of practical uses.

The foregoing is illustrative of some example embodiments of the inventive concepts and is not to be construed as limiting thereof. Although some example embodiments of the inventive concepts have been described, those skilled in the art will readily appreciate that many modifications are possible in some example embodiments without materially departing from the novel teachings and advantages of the present invention. Accordingly, all such modifications are intended to be included within the scope of the present invention as defined in the claims. The present invention is defined by the following claims, with equivalents of the claims to be included therein.

It should be understood that example embodiments described herein should be considered in a descriptive sense only and not for purposes of limitation. Descriptions of features or aspects within example embodiments should typically be considered as available for other similar features or aspects in other example embodiments.

What is claimed is:

1. A writing and reading method of a nonvolatile storage, that includes a first partition and a second partition, and is configured to allow a read operation and a write operation with respect to the second partition only when an authentication is successful in a normal mode, the writing and reading method comprising:
assigning a part of a storage space of the second partition to a temporary area by the nonvolatile storage according to a request of changing the normal mode to a secure temporary mode; and
writing data to the temporary area by the nonvolatile storage;
wherein the nonvolatile storage allows the read operation with respect to the temporary area without the authentication.

2. The writing and reading method of claim 1, wherein the temporary area is assigned when a capacity of a free storage space of the first partition is smaller than a size of the data.

3. The writing and reading method of claim 1, further comprising:
receiving information of a capacity of the temporary area by the nonvolatile memory;
wherein the temporary area is assigned according to the information of the capacity.

4. The writing and reading method of claim 3, wherein the temporary area is assigned when the capacity of the temporary area is smaller than a capacity of a free storage space of the second partition.

5. The writing and reading method of claim 1, wherein the assigning of the part of the storage space to the temporary area comprises extending the first partition so that addresses of the part of the storage space is included in the first partition.

6. The writing and reading method of claim 5, wherein the part of the storage space belongs to both the second partition and the first partition.

7. The writing and reading method of claim 1, wherein the assigning of the part of the storage space to the temporary area comprises generating a temporary partition by separating the part of the storage space from the second partition, and
wherein the nonvolatile storage allows the read operation with respect to the temporary partition without the authentication.

8. The writing and reading method of claim 1, wherein the temporary area is assigned when a capacity of a free storage space of the first partition is smaller than a size of the data, and a capacity of a free storage space of the second partition is greater than the size of the data.

9. The writing and reading method of claim 1, further comprising:
receiving addresses of the part of the storage space to be assigned to the temporary area by the nonvolatile storage.

10. The writing and reading method of claim 9, wherein the assigning of the part of the storage space to the temporary area comprises storing the received addresses by the nonvolatile storage, and
wherein the nonvolatile storage allows the read operation or the write operation without the authentication based on the stored addresses.

11. The writing and reading method of claim 1, wherein the part of the storage space is selected from a free storage space of the second partition.

12. The writing and reading method of claim 1, further comprising:
after the read operation of the temporary area, receiving an end request by the nonvolatile storage; and
releasing the part of the storage space from the temporary area by the nonvolatile storage according to the end request.

13. The writing and reading method of 12, further comprising:
receiving a delete request of the data written in the temporary area in conjunction with the end request by the nonvolatile storage; and
deleting the data according to the delete request by the nonvolatile storage.

14. The writing and reading method of 12, further comprising:
deleting the data written in the temporary area by the nonvolatile storage according to the end request.

15. A nonvolatile storage, comprising:
a nonvolatile memory forming a storage area; and
a memory controller configured to access the storage area,
wherein the storage area is configured to be divided into a first partition and a second partition,
wherein the second partition is configured to be set to be accessed according to an external request after an authentication is successful in a normal mode,
wherein a part of the storage area of the second partition is re-configured to be accessed without the authentication according to the external request in a secure temporary mode.

16. An operating method of a computing device that includes a nonvolatile storage and a processor, wherein the nonvolatile storage includes one or more normal partitions and one or more secure partitions, and wherein the processor is configured to access the nonvolatile memory, the operating method comprising:
in a first mode, assigning a part of a storage space of at least one of the one or more secure partitions to a temporary area by the nonvolatile storage in response to a request from the processor;
writing data into the temporary area in the secure partition by the processor; and
reading the data from the temporary area in a second mode by the processor;
wherein the nonvolatile storage is configured to allow read operations with respect to the one or more secure partitions only when an authentication is successful in the first mode, and
wherein the nonvolatile storage is further configured to allow the read operations with respect to the temporary area without the authentication in the second mode.

17. The operating method of claim 16, wherein at the first mode, the processor is configured to access the one or more secure partitions after the authentication is successful using a key,
wherein at the second mode, the processor is configured to be unable to obtain the key.

18. The operating method of claim 17, wherein the written data is for updating an operating system or a firmware.

19. The operating method of claim 16, further comprising:
releasing the temporary area after reading the written data by the processor.

20. The operating method of claim 19, further comprising:
deleting the written data when the temporary area is released by the nonvolatile storage.
